(19) United States
(12) Patent Application Publication
(10) Pub. No.: US 2019/0166969 A1
(43) Pub. Date: Jun. 6, 2019

(54) Portable Pop-up Wig and Accessory Drying Apparatus

(71) Applicant: Marcus Brownlee, Upper Marlboro, MD (US)

(72) Inventor: Marcus Brownlee, Upper Marlboro, MD (US)

(21) Appl. No.: 16/268,498

(22) Filed: Feb. 6, 2019

(51) Int. Cl. A45D 20/12; A45D 20/14; F26B 21/00; F26B 25/06

(52) U.S. Cl. CPC A45D 20/12; A45D 20/14; A41G 3/00; F26B 25/06; F26B 21/004

(57) ABSTRACT

Portable pop-up wig and accessory drying apparatus may allow personnel a portable means to dry wigs and small accessories quickly in a preferred embodiment of the invention. The invention may include an assembly of a specially configured pop-up enclosure, a piping system that strategically channels cool, warm or hot air to specific saturated portions of the articles and a mounting surface for a wig or accessories that may be attached to one end of the piping system. Forced air may be provided from an external source that connects to an adapter port that is external to the enclosure. The forced air may be channeled through the piping system in the enclosure up to the accessories or wig cap, which is usually the most saturated with moisture. The residual air may also flow through the perforations in the piping and dries the lower portion of the wig or accessories and may then escape the enclosure through strategically placed holes in the top or body of the enclosure.

### BACKGROUND OF INVENTION

The present invention generally relates to portable dryers and more particularly, to a compressible Pop-up enclosure, which houses a detachable piping system that channels air directly to highly moisture saturated areas and utilizes an external forced air heat source that connects to the piping to dry wigs and accessories.

Wigs have become a normal way of life due to the low maintenance and ease of style changes. However, just like a person's natural hair, wigs need to be washed and dried. Drying a wet wig by hanging will take multiple hours or if a hand dryer is used, the user will have to manually dry the hair, which also requires a lot of time and effort.

With today's fast paced lifestyles, wig wearers need a quick and portable means of drying small accessories such as socks, gloves, scarves hats etc. The wig and accessory dryer can be used in the home, dorm or even be used with a battery operated or cordless blow dryer for total portability.

### SUMMARY OF THE INVENTION

In one aspect of the present invention, a Pop-up wig and accessory drying apparatus is provided. The enclosure is made of a heat resistant and malleable substance, which can be compressed to a disc or flat shape, yet firm enough to be free standing when erect or may be supported by a wire with spring like action enclosed in a sleeve and wound in a spiral pattern 2 around the enclosure to hold it erect. This is considered a pop-up design. The enclosure has a zippered opening, which allows accessibility to the internal portion of the enclosure. The bottom of the enclosure consists of a hard flat horizontal tray with a vertically raised wall for stability and support of the pop-up enclosure. The raised portion of the tray has a hole that serves as a pass-thru and mounting point for the horizontal intake portion of a piping system. The piping system consists of multiple removable solid wall and perforated pipes, adjoined together to direct airflow throughout the chamber. The internal end of the horizontal intake pipe is attached to an elbow that is mounted to bottom tray of the enclosure. The opposite end of the horizontal intake pipe protrudes through the external wall of the raised edge of the hard bottom tray. The protruding end of the horizontal intake pipe connects to a removable external receiving port that is designed to attach to different size adapters that accept the air outlet end of a hair dryer.

Internal piping consists of the horizontal intake pipe, which connects to the elbow that is attached to the bottom tray. The opposite end of the elbow connects to a vertical accessory attaching device. The wig or accessory is placed on or attached to the supporting device. When all pipes are connected, the apparatus dries a wig or accessory such as socks, hats, gloves etc., by forced warm or hot air from a hair dryer. The hair dryer sits in the external receiving port adapter and forces air through the horizontal intake pipe. The air is channeled through the intake pipe, the elbow and then through the vertical perforated solid wall pipe up to the wig supporting device. The channeled air is designed to dry the wig cap or accessory quickly, while the residual air flows through the wig cap and the perforated portion of the piping, which dries the remaining strands of the wig or hanging portion of the accessory. Holes 3 are strategically placed throughout the sides of the enclosure to serve as exhaust ports for the forced air. A commercial version of this apparatus consists of the same piping and design with the exception of the enclosure. The commercial enclosure is hard sided and does not compress. The commercial version has the option of connecting to commercial grade forced air device or standard hand held hand dryer.

These and other features, aspects and advantages of the present invention will become better understood with reference to the following drawings, description and claims.

### BRIEF DESCRIPTION OF THE DRAWINGS

FIG. 1 is a side perspective view of an exemplary embodiment of a wig and accessory drying apparatus of the present invention with piping, supports and having a single wig capacity;

FIG. 2 is a front perspective view of an exemplary embodiment of a wig and accessory drying apparatus of the present invention with a wig placed on the wig and accessory support.

FIG. 3 is a side section view of the horizontal and vertical perforated piping, elbow, blow dryer port, wig and accessory support and adapter.

FIG. 4 is a perspective view of the collapsible wig and accessory support.

FIG. 5 is a perspective view of the enclosure in the compressed configuration.

FIG. 6 is a perspective view of the tray and enclosure in the erect configuration.

FIG. 7 is a top perspective view of the commercial version of the wig and accessory drying apparatus.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a compressing chamber and internal removable piping system to channel heat and air from an external forced air source to dry wigs and accessories.

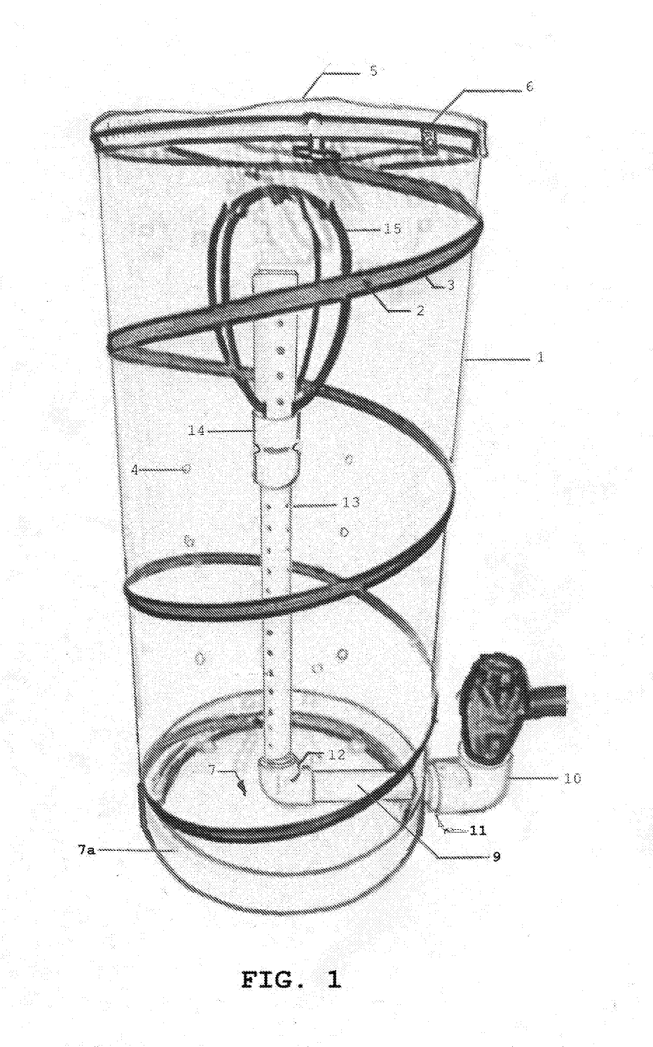

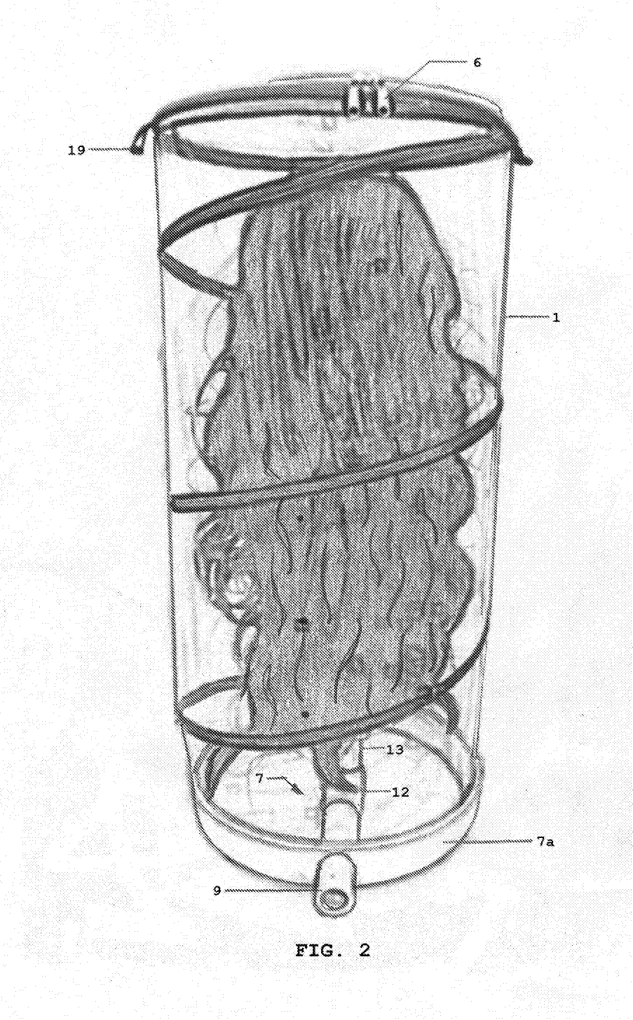

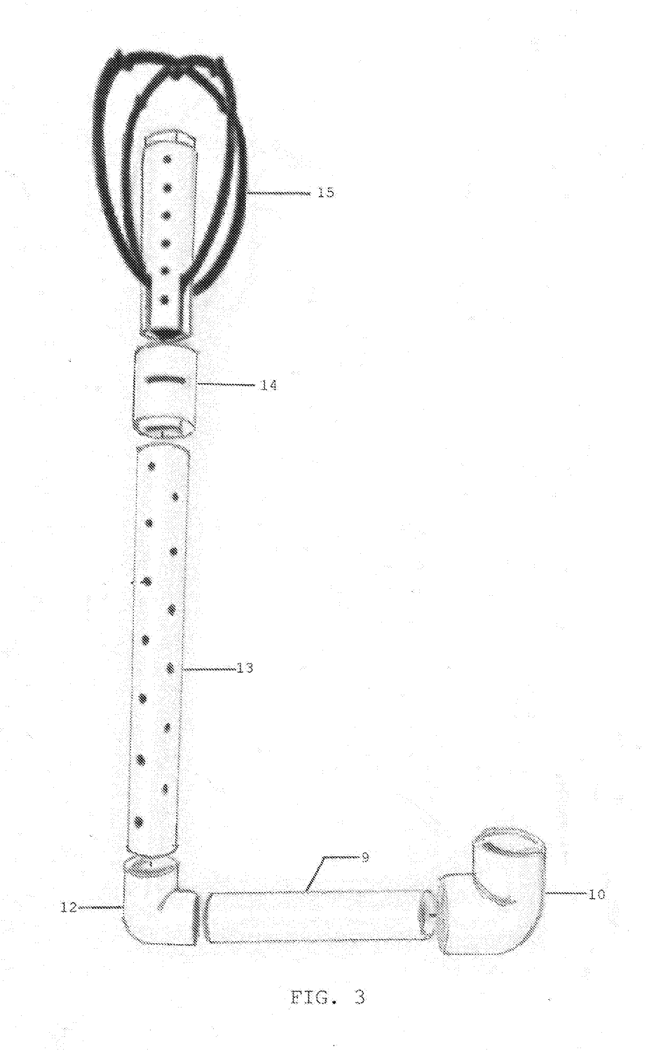

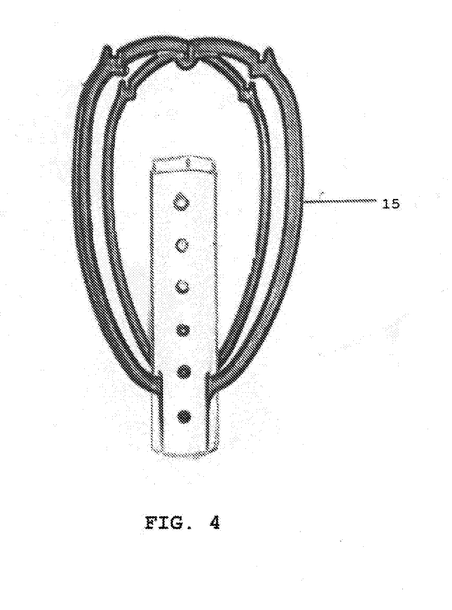

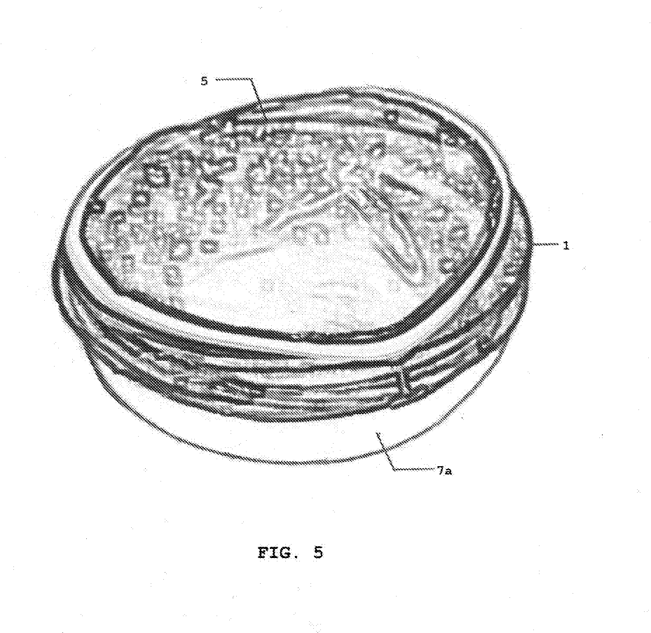

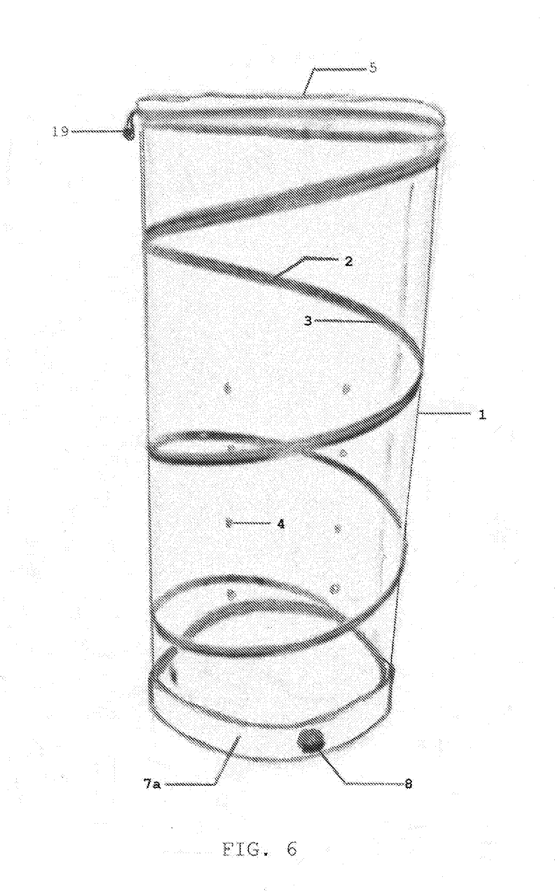

Referring to FIGS. 1-6, a portable apparatus for drying a single wig is shown according to an exemplary embodiment of the present invention. The apparatus may include a cylindrical enclosure 1 formed of a heat resistant and malleable substance so that it can be compressed to a disc or flat shape for stowage and portability. The enclosure may be free standing or include a compressible wire 2 with spring type resistance, which is enclosed in a sleeve 3 that is wrapped around the enclosure in a spiral pattern from top to bottom. The spring wire 2 may support the enclosure 1 in the erect configuration. The enclosure 1 may have strategically placed holes 4 to act as exhaust ports for the forced air. The top of the enclosure 5 may have a zipper 6 that connects the top 5 to the body of the enclosure 1 and allows accessibility to the internal portion of the enclosure 1 when unzipped. The top 5 may also be made of a heat resistant and malleable substance. The top 5 may also have tie down straps 19 to lock the enclosure in the compressed configuration for stowage or transport. The bottom of the enclosure may rest on a hard flat horizontal tray 7 with a vertically raised wall 7a for stability and support of the pop-up enclosure 1. The raised portion of the tray 7a also may contain a hole 8 that serves as a pass-thru and mounting point for the horizontal intake pipe 9. One end of the horizontal intake pipe 9 may connect to a mounting port 10 that may be external to the enclosure 1 and may accept the outlet of a hand held type blow dryer. Adapters 11 may be used to compensate for the different sizes of the blow dryer air outlets.

The opposite end of the horizontal inlet pipe 9 may connect to an elbow 12 that may be attached to the hard tray 7. The opposite side of the elbow 12 may connect to one end of a removable solid walled or perforated pipe 13 or combination of pipes that stand vertically in the enclosure 1 when it is in its erect configuration. The opposite side of the vertical standing pipe 13 may connect to an adapter 14 that accepts a collapsible wig and accessory support 15.

To use the apparatus, the bottom tray 7, which is attached to the enclosure 1 may be placed on a flat surface. The tie down straps 19 may be released to allow the enclosure 1 to pop up to its erect configuration. The zipper 5 may be unzipped and the piping, which may be stored in the enclosure, may be assembled. The horizontal intake pipe 9 may be connected to the horizontal end of the elbow 12 and the opposite end of the horizontal intake pipe 9 may protrude out of the enclosure 1 through the hole 8 in the vertical side of the tray 7a. The vertical perforated pipe 13 may be slid into the vertical end of the elbow 12. The wig and accessory support adapter 14 may be placed on the top of the vertical pipe 13. The wig and accessory support 15 may be placed on the support adapter 14. A wig or various accessories may be placed on the support. The top 5 may be closed with the zipper 6. The blow dryer port 10 and adapter 11 may be attached to the external side of the horizontal intake pipe 9. The blow dryer may be put into the receiving side of the port 10. The blow dryer may be activated, which may blow cool, warm or hot air through the piping system into the enclosure. The piping system may direct the air to through the horizontal intake pipe 9 to the top of the vertical pipe 13 and support adapter 14 to dry the wig cap. The residual air may escape through the wig and perforated pipe 13 to dry the hanging portion of the wig or accessory. To prevent the enclosure from over expanding from air pressure, the excess air may escape through the exhaust ports 4 in the side of the enclosure 1.

After the items have dried, the hair dryer may be turned off and removed from the port 10. The zipper 6 may be unzipped and the items removed. The vertical pipe 13 wig and accessory support 15 and adapter 14 may be disassembled and placed horizontally at the bottom of the tray 7. The blow dryer port 10 may be removed and placed in the bottom of the tray 7. The zipper 6 may be closed and the enclosure 1 may be compressed to a disc shape for stowage and portability.

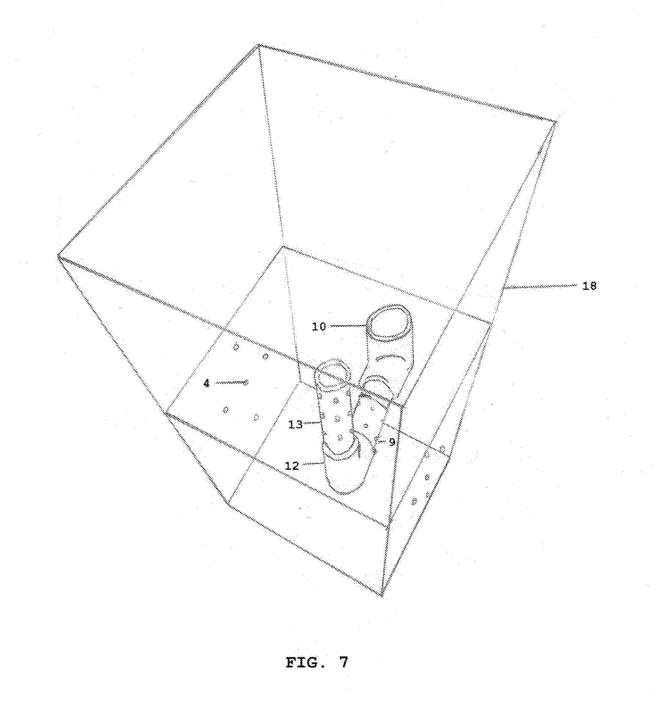

Referring to FIG. 7, a hard sided enclosure composed of a heat resistant hard substance such as plastic for the purpose of commercial use is shown according to another embodiment of the present invention.

In contrast to large cumbersome and expensive wig dryers, or dryers that don't combine a piping system that channels air to the most moisture saturated locations within the enclosure, this design is more efficient and can be used to dry items other than wigs. The design of the present invention is portable, lightweight, easily stowed and versatile.

It should be understood that the foregoing relates to exemplary embodiments of the invention and that modifications may be made without departing from the spirit and scope of the invention as set forth in the following claims.

What is claimed is:

1. A wig and accessory drying apparatus comprised of a soft sided compressing pop-up enclosure and a piping system for the channeling of air for drying wigs and various accessories; the enclosure is cylindrical, square or rectangular in shape; the enclosure is made of a heat resistant and malleable substance, so that it can be compressed to a disc or flat shape for stowage or portability, yet firm enough to be free standing when erect or supported by a wire with spring action inside of a sleeve and wound in a spiral pattern around the enclosure to hold it erect;
the enclosure has tie down straps to lock the enclosure in the compressed configuration for stowage or portability; the enclosure has a zippered opening, which allows accessibility to the internal portion of the enclosure; the bottom of the enclosure consists of a tray made of a hard substance with a flat horizontal bottom and a vertically raised wall for stability and support of the pop-up enclosure; the raised portion also contains a hole that serves as a pass-thru and mounting point for the horizontal intake pipe of the piping system; the piping system consists of multiple removable solid walled or perforated pipes, adjoined together to direct airflow throughout the chamber of the enclosure; the internal end of the horizontal intake pipe is attached to an elbow that is attached to the hard bottom tray; the opposite side of the horizontal intake pipe protrudes through the external wall of the raised edge of the hard bottom tray and soft sided enclosure; the protruding end of the horizontal intake pipe connects to a removable external receiving port that is designed to hold the air outlet end of a hand held hair dryer; internal piping consists of the horizontal intake pipe, which connects to the elbow; the opposite of the elbow connects to a vertical pipe or adjoining pipes, which may be perforated or solid walled; the top of the vertical perforated or solid walled pipe(s) are designed to connect to a collapsible wig and accessory support;
the wig and accessory is placed on or attached to the support;
when all pipes are connected, the apparatus dries a wig or accessories such as socks, hats, gloves etc., by forced cool, warm or hot air from a hair dryer; the hair dryer sits in the external receiving port and forces air through the horizontal intake pipe, elbow and then through the vertical perforated or solid wall pipe up to the wig support; the channeled air is designed to dry the wig cap or accessory quickly, while the residual air flows out of the wig and the perforated pipes, which dries the remaining strands of hair or hanging accessories; holes are strategically placed throughout the sides of the enclosure to serve as exhaust ports for the forced air;
a commercial version of this apparatus consists of the same piping and design with the exception of the enclosure; the commercial enclosure is made of a heat resistant hard substance instead of the soft sided portable enclosure; the horizontal intake pipe has the option of connecting to a hand held blow dryer or a commercial grade forced air device.

2. The Pop-up Wig and Accessory Drying Apparatus claim 1, wherein the pop-up wig and accessory drying apparatus is substantially flat when the enclosure is in the second, compress configuration and has straps to lock itself in the compressed configuration.

3. The Pop-up Wig and Accessory drying Apparatus claim 1, wherein the pop-up wig and accessory drying apparatus is free standing or erected by a spring action wire wrapped around the enclosure in a spiral from top to bottom.

4. The Pop-up Wig and Accessory Drying Apparatus claim 1, wherein the spiral wire supporting the enclosure has a spring like action that is normally in the non-compressed state.

5. The Pop-up Wig and Accessory Drying Apparatus claim 1, further comprising of a zippered door at the top of the enclosure for which the piping, wig or accessories are passed into the chamber of the enclosure.

6. The Pop-up Wig and Accessory Drying Apparatus claim 1, wherein the enclosure in its non-compressed configuration will hold a horizontally configured solid walled or perforated intake pipe that protrudes through the enclosure and is connected to an elbow that is attached to the bottom tray of the enclosure; the opposite side of the elbow connects to a solid walled or perforated pipe in a vertical position; the opposite end of the vertical pipe connects to an adapter to accept the collapsible wig and accessory support.

7. The Pop-up Wig and Accessory Drying Apparatus claim 1, wherein the extruding portion of the horizontal intake pipe connects to a port that is configured to accept the outlet of a hand held hair dryer.

8. The Pop-up Wig and Accessory Drying Apparatus claim 1, wherein the pop up wig and accessory drying apparatus in the compressed configuration may stow the horizontal intake pipe, elbow, collapsed Wig and accessory support, vertical pipe, and adapter once removed from the elbow.
